(19) United States
(12) Patent Application Publication
(10) Pub. No.: US 2014/0374552 A1
(43) Pub. Date: Dec. 25, 2014

(54) Combination-Type Suction Cup Base

(71) Applicant: Garbath Houseware Co., Ltd., Jiangmen City (CN)

(72) Inventor: Xiaowen Zhong, Jiangmen City (CN)

(21) Appl. No.: 14/376,855

(22) PCT Filed: Dec. 26, 2012
(86) PCT No.: PCT/CN2012/087540

§ 371 Date: Aug. 6, 2014

(30) Foreign Application Priority Data
Feb. 7, 2012 (CN) 201210026547.X

(51) Int. Cl. F16B 47/00; F16M 13/02; A47K 5/18

(52) U.S. Cl. CPC F16B 47/00; A47K 5/18; F16M 13/022
USPC 248/205.5; 248/309.3; 248/363

(57) ABSTRACT

A combination-type suction cup base, comprising a mounting base with a through-hole and a screw hole is described. One side of the through-hole is connected with a suction cup with a screw stem which absorbs the base to a wall surface. The screw stem is connected with a cap after passing through the through-hole. The screw hole is located in the region covered by the cap. At least two different object holders are mounted on the base. The base abandons the structure model of a cross rail spanned between two mounting bases and mounting multiple object holders on the cross rail. Thus, the structure is simple and small, with simple, convenient operation, facilitating hanging of objects by consumers, making the washroom, etc. tidier and cleaner. Furthermore, the base can also be fixed to an unsmooth wall surface by means of a screw, broadening the range of use of the-base.

### FIELD OF THE INVENTION

The present invention relates to a suction cup base, in particular to a combination-type suction cup base which combines the mounting of a plurality of different object holders on a mounting base directly and fixedly.

### BACKGROUND OF THE INVENTION

In daily life, for convenience of resting, people tend to rest or hang objects on walls or glass walls, especially for smaller spaces such as washrooms and kitchens, etc. Hanging some small objects such as towels, a toothbrush holder, a soap box, a showerhead base and the like to the walls not only saves space but also makes the whole space neat and attractive, so that suction cup bases comprising multiple object holders for hanging towels or resting toothbrush holders appear in the market. But these suction cup bases usually have one object holder integrally formed on the mounting base which is fixed to the wall surface, or have a plurality of same object holders, for example a row of hooks, formed integrally on one mounting base. In washrooms or kitchens, when needing to hang or rest the towel, the tooth brush, the soap and the showerhead at the same time, a user may have to fixedly mount a separate suction cup base with a towel ring, a separate suction cup base with the toothbrush holder, a separate suction cup base with the soap box and a separate suction cup base with the showerhead base on the wall surface at the same time. Considering the molding of the whole suction cup base, it is very difficult to mold several different object holders on the same suction cup base, which greatly increases the manufacturing cost and lowers the production efficiency of the suction cup base. Therefore, the combined-type suction cup base which comprises at least two mounting bases, has a cross rail spanned between adjacent mounting bases and has a plurality of object holders arranged on the cross rail appears in our country. However, the suction cup base of such a structure is space consuming, is relatively complex in structure, has more parts and requires manual mounting of the cross rail and the like by the user. Besides, the suction cup base is aesthetically undesirable and troublesome in operation, so that it cannot meet people's requirements for easy operation and simple and beautiful space layout of kitchen and bathroom.

### SUMMARY

In order to overcome the deficiencies of the prior art, the present invention provides a suction cup base which comprises a mounting base on which a plurality of different object holders can be mounted in a combined manner, is simple and reasonable in structure, provides easy mounting and takes up less space.

The technical scheme that the present invention adopts to solve its technical problems is:

a combined-type suction cup base, comprising a mounting base with a through hole and a screw hole for passing a screw which is used to fix the mounting base onto a wall surface, wherein one side of the through hole is connected with a suction cup with a screw stem which absorbs the mounting base to the wall surface, and the screw stem on the suction cup is in screw connection with a cap after passing through the through hole, the screw hole being located in the region covered by the cap. At least two different object holders are directly and fixedly mounted on the mounting base, and an object holder mounting hole in which a first screw rests is arranged on the mounting base, the first screw being connected with the object holder after passing through the object holder mounting hole.

As an improvement to the above technical scheme, the suction cup base further comprises screw stem fittings in screw connection with the cap, and the cap comprises a suction cup lid and a soft rubber ring sleeved on the suction cup lid and used for increasing the frictional force when screwing the cap.

As a further improvement to the above technical scheme, one side of the mounting base adjacent to the wall surface is provided with a first annular rib and a second annular rib that compress the suction cup.

Preferably, the object holder is a towel ring, a soap box, a toothbrush holder, a seasoning box, a hair dryer holder, a showerhead base, a plastic hook or a tissue box.

A combined-type suction cup base comprises a mounting base with a through hole and a screw hole for passing a screw which is used to fix the mounting base onto a wall surface, wherein one side of the through hole is connected with a suction cup with a screw stem which absorbs the mounting base to the wall surface, and the screw stem on the suction cup is in screw connection with a cap after passing through the through hole, the screw hole being located in the region covered by the cap. At least two different object holders are directly and fixedly mounted on the mounting base, a square hole is arranged on the mounting base, a clasp corresponding to the square hole is arranged on the object holder, and the object holder is fastened to the square hole in the mounting base by the clasp.

As an improvement to the above technical scheme, the suction cup base further comprises screw stem fittings in screw connection with the cap, and the cap comprises a suction cup lid and a soft rubber ring sleeved on the suction cup lid and used for increasing the frictional force when screwing the cap.

As a further improvement to the above technical scheme, one side of the mounting base adjacent to the wall surface is provided with a first annular rib and a second annular rib that compress the suction cup.

A combined-type suction cup base comprises a mounting base with a through hole and a screw hole for passing a screw which is used to fix the mounting base to a wall surface, wherein one side of the through hole is connected with a suction cup with a screw stem which absorbs the mounting base to the wall surface, and the screw stem on the suction cup is in screw connection with a cap after passing through the through hole, the screw hole being located in the region covered by the cap. At least two different object holders are directly and fixedly mounted on the mounting base, and a concave platform is arranged at the front part of the mounting base. On both sides of the concave platform are grooves recessed along the left and right sides, and one edge of the groove forms a boss. The bottom of the concave platform is of a hollow structure, slots corresponding to the bosses are arranged on the left and right sides of the object holder, and a notch is arranged at the bottom end of the slot. A trapezoidal projection is arranged on one side facing away from the center of the object holder along the left and right direction, of the edge of the slot adjacent to the mounting base, corresponding to an extension part of the notch. A bottom slot is arranged at the bottom end of the object holder, the object holder is in plug-in connection with the boss on the mounting base through the slot, the trapezoidal projection on the slot abuts against the bottom edge of the concave platform, an upper top edge of the object holder is fastened to the top edge of the mounting base, and two slot edges of the bottom slot of the object holder are located at two sides of the hollow structure of the concave platform.

As an improvement to the above technical scheme, the suction cup base further comprises screw stem fittings in screw connection with the cap, and the cap comprises a suction cup lid and a soft rubber ring sleeved on the suction cup lid and used for increasing the frictional force when screwing the cap.

As a further improvement to the above technical scheme, one side of the mounting base adjacent to the wall surface is provided with a first annular rib and a second annular rib that compress the suction cup.

The beneficial effects of the present invention are described as follows. The suction cup base has a plurality of different object holders mounted on one mounting base in a combined manner, abandoning the combined model of spanning a cross rail between two mounting bases and mounting multiple different object holders on the cross rail. Thus, the suction cup base is simple and reasonable in structure, occupies less space, and is simple and convenient in operation, thereby meeting the consumers' personalized requirements of resting or hanging different objects, greatly facilitating the hanging or resting of objects by the consumer in the washroom or kitchen and the like, and making the whole washroom or kitchen more tidy and clean. Moreover, the suction cup base may also be fixed to an unsmooth wall surface by the screw, enlarging the range of use of the suction cup base.

### BRIEF DESCRIPTION OF DRAWINGS

The present invention will be described with reference to drawings and embodiments.

FIG. 1 is a structural schematic diagram of the first combined-type suction cup base of the present invention;

FIG. 2 is a structural schematic diagram of the second combined-type suction cup base of the present invention;

FIG. 3 is an exploded schematic diagram of FIG. 1;

FIG. 4 is a structural schematic diagram of a mounting base of FIG. 1;

FIG. 5 is a structural schematic diagram of a screw stem fitting of the present invention;

FIG. 6 is an exploded schematic diagram of FIG. 2;

FIG. 7 is a structural schematic diagram of the third combined-type suction cup base of the present invention;

FIG. 8 is an exploded schematic diagram of FIG. 7;

FIG. 9 is a structural schematic diagram of an inner wall of a hook object holder of FIG. 7;

FIG. 10 is a structural schematic diagram of a side wall of a hook object holder of FIG. 7;

FIG. 11 is a structural schematic diagram of the mounting base with a cap and a suction cup (the suction cup being blocked) of FIG. 7;

FIG. 12 is a structural schematic diagram of a soft rubber ring of the present invention;

FIG. 13 is a structural schematic diagram of the second combined-type suction cup base of the present invention, wherein the object holder is divided into a mounting part and an object-holding part;

FIG. 14 is an exploded schematic diagram of FIG. 13;

FIG. 15 is a structural schematic diagram of the third combined-type suction cup base of the present invention, wherein the object holder is divided into a mounting part and an object-holding part;

FIG. 16 is an exploded schematic diagram of FIG. 15;

FIG. 17 is a structural schematic diagram of the first combined-type suction cup base of the present invention, with part of the object holder, the cap and the suction cup hidden; and

FIG. 18 is a sectional view of section A-A of FIG. 17.

### DETAILED DESCRIPTION OF THE EMBODIMENTS

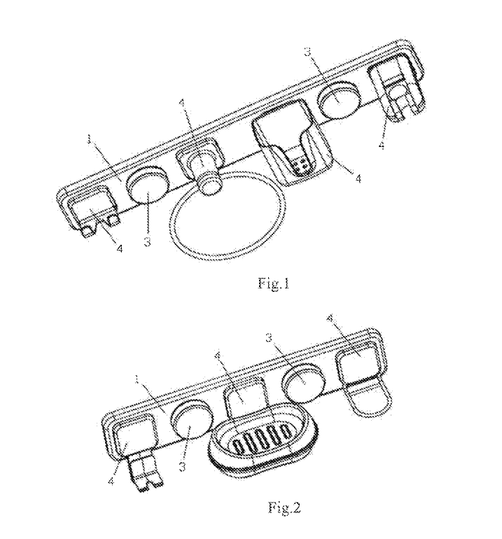

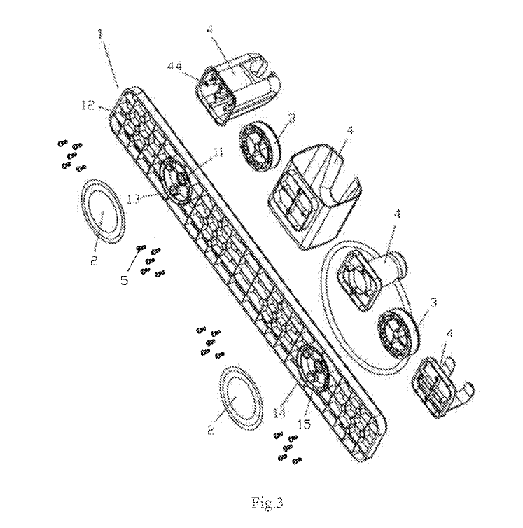

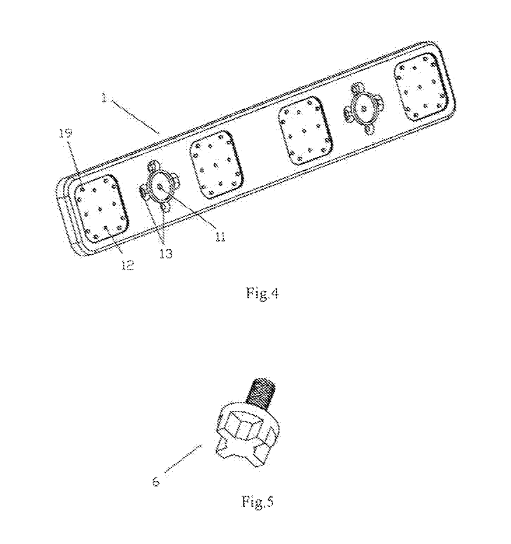

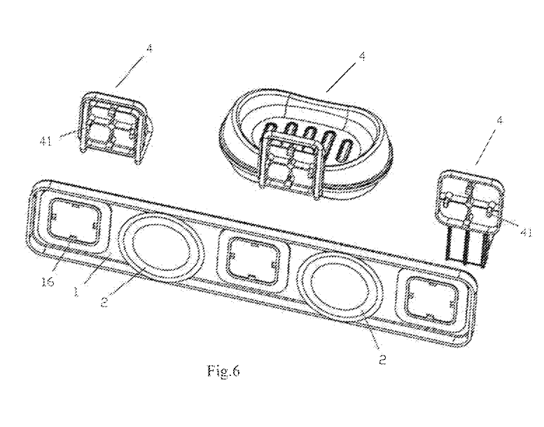

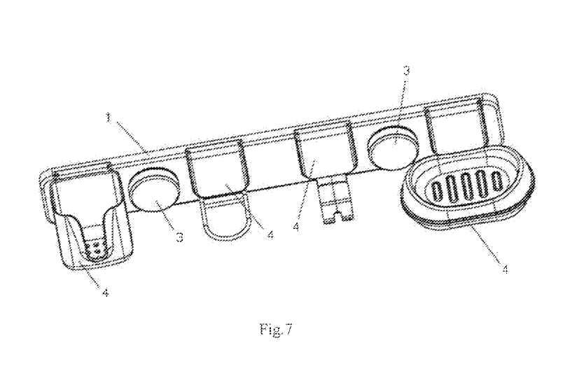

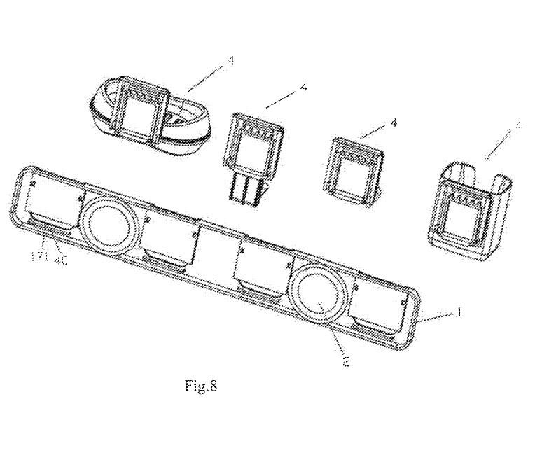

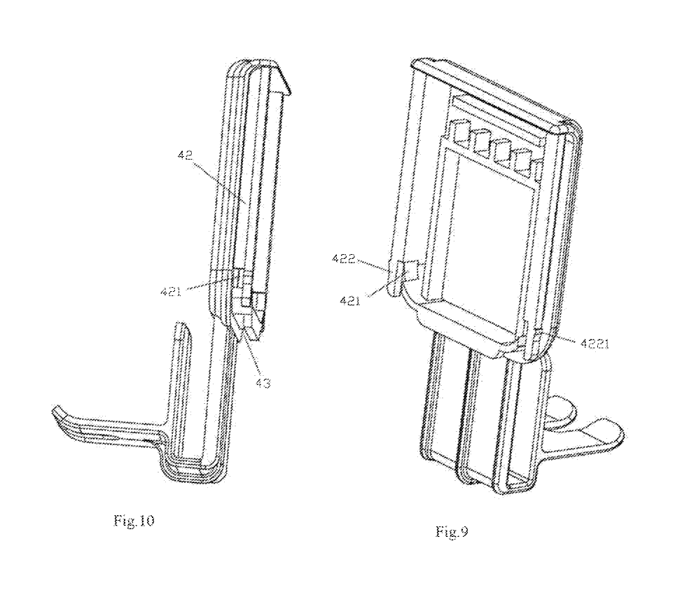

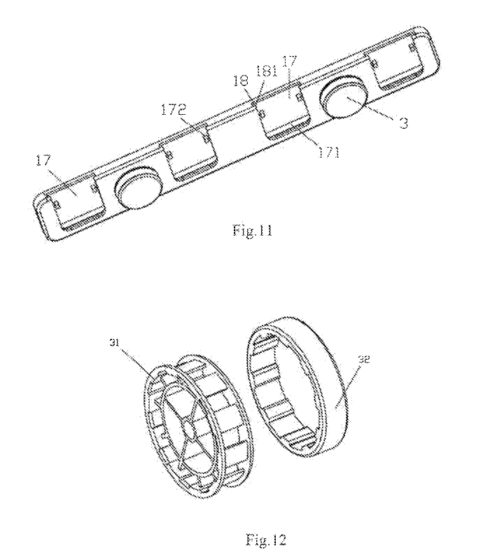

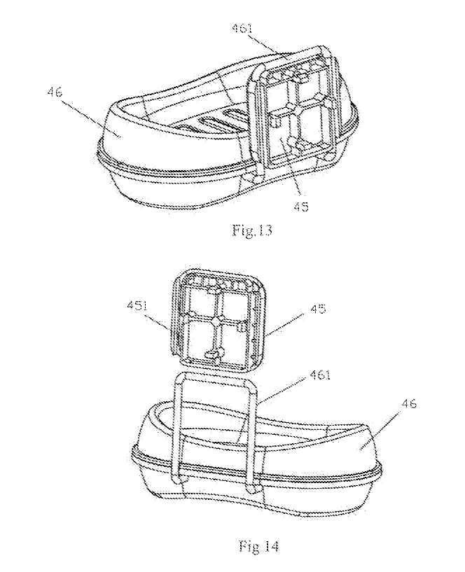

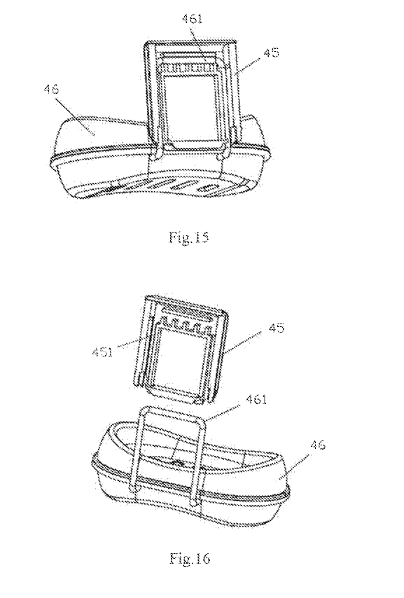

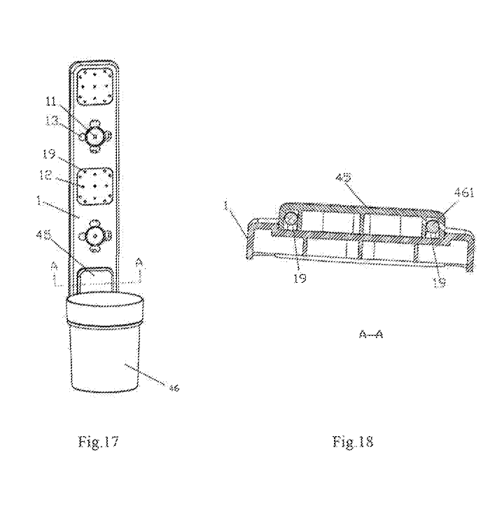

Referring to FIGS. 1 to 18, a combined-type suction cup base of the present invention comprises a mounting base 1, wherein the mounting base 1 is provided with a through hole 11, one side of the through hole 11 is connected with a suction cup 2 with a screw stem (being blocked by the suction cup 2 and not shown in the drawings) which absorbs the mounting base 1 to the wall surface, and the screw stem on the suction cup 2 is in screw connection with a cap 3 after passing through the through hole 11. When needing to fix the mounting base 1 on a smooth wall surface, a vacuum state is formed between the suction cup 2 and the contact surface of the wall by screwing the cap 3 so as to absorb the mounting base 1 to the wall surface. In order to increase the hand feeling and frictional force when screwing the cap 3, the cap 3 may consists of a suction cup lid 31 and a soft rubber ring 32 sleeved on the suction cup lid 31. The soft rubber ring 32 may increase the frictional force between the hand and the cap 3 when screwing the cap 3 such that the mounting base 1 may absorb to the smooth wall surface more firmly through the suction cup 2. Meanwhile, after the suction cup base is used for a long time, loss of vacuum of the suction cup 2 and thus insufficient suction durability occurs as the air may enter the suction cup 2 slowly, thereby resulting in the falling off of the suction cup base from the wall surface. Therefore, the suction cup base of the present invention is further provided with a first annular rib 14 and a second annular rib 15 for compressing the suction cup 2 on the inner surface of the mounting base 1. In this way, while screwing up the cap 3 to press the suction cup 2 so as to allow the suction cup 2 to form the suction force, the first annular rib 14 and the second annular rib 15 may apply uniform pressure to the periphery of the suction cup 2 at the same time, which prevents the air from entering due to the deformation at the contact surface between the suction cup 2 and the wall surface. Even after a long time use, as the air may not enter the contact surface between the suction cup 2 and the wall surface easily, the suction cup 2 still has enough suction force to ensure the durability and fastness of the mounting and fixing of the suction cup base. The first annular rib 14 and the second annular rib 15 are used to decrease the contact area between each annular rib and the suction cup 2 so as to increase the pressure applied by the annular ribs to the suction cup 2, allowing the annular ribs to better compress the suction cup 2, such that the suction cup 2 will absorb the whole suction cup base to the smooth wall surface more firmly and durably. Moreover, for some wall surfaces that are not so smooth, since the suction cup 2 cannot be used to fix the mounting base 1 to the wall surface, the mounting base 1 is further provided with a screw hole 13 for passing a screw which is used to fix the mounting base 1 onto a wall surface. The suction cup 2 uses a screw stem fitting 6 which is in screw connection with the cap 3 instead, and the screw hole 13 is located in the region covered by the cap 3. In mounting, the process comprises the following steps of taking down the suction cup 2 first, then passing the screw stem fitting 6 through the through hole 11, and then passing the screw (not shown in the Figure) through the screw hole 13 to fix the mounting base 1 to the wall surface, finally screwing the cap 3 up on the screw stem fitting 6. By fixing the whole suction cup base on the wall surface through the screw, the usable range of the suction cup base of the present invention is broaden. While the screw hole 13 is formed in the region covered by the cap 3 so as to be obstructed by the cap 3 when using the suction cup 2. While the suction cup base is fixed on the wall surface by the screw, the cap 3 may block the screw hole 13 and the screw that fixes the suction cup base on the wall surface at the same time so as to enhance the aesthetics of the whole suction cup base.

At least two different object holders are directly and fixedly mounted on the mounting base 1, and the object holder 4 may be a towel ring, a soap box, a toothbrush holder, a seasoning box, a hair dryer holder, a showerhead base, a plastic hook, a tissue box, etc. The mounting base 1 is provided with an object holder mounting hole 12 in which a first screw 5 rests, and the first screw 5 is connected with the object holder 4 after passing through the object holder mounting hole 12. A platform surface for resting the first screw 5 is arranged on the inner wall of the object holder mounting hole 12, and a mounting screw hole 44 corresponding to the first screw 5 is arranged on the object holder 4. After passing the first screw 5 through the object holder mounting hole 12, the head of the first screw 5 is against the platform surface of the inner wall of the object holder 12, and the screw stem of the first screw 5 is inserted into the mounting screw hole 44 to be in screw connection with the object holder 4, thus mounting the object holder 4 on the mounting base 1 fixedly. As the mounting base 1 and the object holder 4 are separated when not mounted together, the difficulty of molding when a plurality of different object holders 4 are formed integrally on the mounting base 1 is avoided, such that a plurality of different object holders may be mounted on one mounting base 1 at the same time, abandoning the structural model of spanning a cross rail between two mounting bases and mounting multiple different object holders on the cross rail. Thus, the suction cup base is simple and reasonable in structure, occupies less space, and is simple and convenient in operation, allowing consumers to mount different object holders 4 on the mounting base in a combined manner according to their own needs without having to mount a plurality of suction cup bases with different object holders 4 on the wall surface to meet their personalized requirements of resting or hanging different objects, thereby greatly facilitating the hanging or resting of objects by the consumer in the washroom or kitchen and the like, making the whole washroom or kitchen more tidy and clean. In addition, the mounting base 1 is generally applicable to different object holders 4, allowing the adoption of a separate molding process for different object holders 4. Compared with the process of forming the object holder 4 and the mounting base 1 integrally, the structure of the mould is greatly simplified, the production cost of the mould is lowered, and design and mass production is needed only for the object holders 4 that makes the production efficiency significantly improved.

A second combined-type suction cup base comprises a mounting base 1, wherein the mounting base 1 is provided with a through hole 11 and a screw hole 13 for passing a screw which is used to fix the mounting base 1 to a wall surface, one side of the through hole 11 is connected with a suction cup 2 with a screw stem which absorbs the mounting base 1 to the wall surface, and the screw stem on the suction cup 2 is in screw connection with a cap 3 after passing through the through hole 11, the screw hole 13 being located in the region covered by the cap 3. At least two different object holders 4 are directly and fixedly mounted on the mounting base 1, a square hole 16 is arranged on the mounting base 1, a clasp 41 corresponding to the square hole 16 is arranged on the object holder 2, and the object holder 4 is fastened to the square hole 16 in the mounting base 1 by the clasp 41. When mounted, the object holder 4 may be easily fixedly mounted on the mounting base 1 just by inserting the object holder 4 into the square hole 16 by using the clasp 41 thereon, such that different object holders 4 are mounted on the same mounting base 1 in a combined manner conveniently and rapidly. Thus, the consumers personalized requirements of resting or hanging different objects are satisfied, and the object holder occupies less space and is simple and compact in structure.

As an improvement to the above embodiment, the suction cup base further comprises a screw stem fitting 6 in screw connection with the cap 3, and the cap 3 comprises a suction cup lid 31 and a soft rubber ring 32 sleeved on the suction cup lid 31 for increasing the frictional force when screwing the cap 3. The provision of the screw stem fitting 6 makes the whole suction cup base more attractive in use, and the provision of the soft rubber ring 32 increases the frictional force between the hand and the cap 3 when screwing the cap 3, thereby preventing the occurrence of a slip between the hand and the cap 3 when screwing the cap 3 to absorb the suction cup 4 to the smooth wall surface.

As a further improvement to the above embodiment, one side of the mounting base 1 adjacent to the wall surface is provided with a first annular rib 14 and a second annular rib 15 for compressing the suction cup 2. The first annular rib 14 and the second annular rib 15 increase the suction force and the durability of the suction cup 2 on the wall surface.

A third combined-type suction cup base comprises a mounting base 1, wherein the mounting base 1 is provided with a through hole 11 and a screw hole 13 for passing a screw which is used to fix the mounting base 1 to a wall surface, one side of the through hole 11 is connected with a suction cup 2 with a screw stem which absorbs the mounting base 1 to the wall surface, and the screw stem on the suction cup 2 is in screw connection with a cap 3 after passing through the through hole 11, the screw hole 13 being located in the region covered by the cap 3. At least two different object holders 4 are directly and fixedly mounted on the mounting base 1, and a concave platform 17 is arranged at the front part of the mounting base 1. On both sides of the concave platform 17 are grooves 18 recessed along the left and right sides, and one edge of the groove 18 forms a boss 181. The bottom of the concave platform 17 is of a hollow structure 171, slots 42 corresponding to the bosses 181 are arranged on the left and right sides of the object holder 4, and a notch 421 is arranged at the bottom end of the slot 42. A trapezoidal projection 4221 is arranged on one side, facing away from the center of the object holder 4 along the left and right direction, of the edge of the slot 42 adjacent to the mounting base 1, corresponding to an extension part 422 of the notch 421. A bottom slot 43 is arranged at the bottom end of the object holder 4, the object holder 4 is in plug-in connection with the boss 181 on the mounting base 1 through the slot 42, the trapezoidal projection 4221 on the slot 42 abuts against the bottom edge of the concave platform 17, an upper top edge of the object holder 4 is fastened to the top edge of the mounting base 1, and two slot edges of the bottom slot 43 of the object holder 4 are located at two sides of the hollow structure 171 of the concave platform. When mounting, after the slot 42 of the object holder 4 is aligned with the boss 181 formed by one edge of the groove 18, and the object holder 4 is connected on the mounting base 1 in a plug-in manner from top to bottom. At this time, the trapezoidal projection 4221 on the object holder 4 just passes through the concave platform 17 and is in the hollow structure 171. Besides, the trapezoidal projection 4221 abuts against the bottom edge of the concave platform 17 so as to prevent the object holder 4 from moving along a vertical direction. The upper top edge of the object holder 4 is fastened to the top edge of the mounting base 1 so as to support the object holder 4. The two edges of the bottom slot 43 of the object holder 4 are located at two sides of the hollow structure 171 of the concave platform so as to locate the object holder 4 at its horizontal normal direction. The provision of the notch 421 makes the edge of the slot 42 adjacent to the mounting base 1 corresponding to the extension part 422 of the notch 421 contract in the left and right direction under a force, such that the trapezoidal projection 4221 may contract inwardly to facilitate the insertion of the object holder 4 or release from the bottom edge of the concave platform 17 to facilitate the taking out of the object holder 4 for replacement. Besides, in order to increase the hearing capacity of the object holder 4 in the vertical direction and allow the object holder 4 to be subjected to a more uniform force, a bearing rib 40 may be arranged below the edge of the bottom slot 43 on one side of the mounting base 1 adjacent to the wall surface (i.e., the inner side), such that one edge of the bottom slot 43 abuts against the hearing rib 40, thereby avoiding the upper top edge of the object holder 4 from totally hearing the force born by the object holder 4 in the vertical direction.

As an improvement to the above embodiment, the suction cup base further comprises a screw stem fitting 6 in screw connection with the cap 3, and the cap 3 comprises a suction cup lid 31 and a soft rubber ring 32 sleeved on the suction cup lid 31 for increasing the frictional force when screwing the cap 3. The provision of the screw stem fitting 6 makes the whole suction cup base more attractive in use, and the provision of the soft rubber ring 32 increases the frictional force between the hand and the cap 3 when screwing the cap 3, thereby preventing the occurrence of a slip between the hand and the cap 3 when screwing the cap 3 to absorb the suction cup 4 to the smooth wall surface.

As a further improvement to the above embodiment, one side of the mounting base 1 adjacent to the wall surface is provided with a first annular rib 14 and a second annular rib 15 for compressing the suction cup 2. The first annular rib 14 and the second annular rib 15 increase the suction force and the durability of the suction cup 2 on the wall surface.

Moreover, for a relatively complicated object holder 4, the object holder 4 may be divided into a mounting part 45 and an object-holding part 46, as shown in FIGS. 13 to 18, wherein the mounting part 45 is fixedly mounted to the mounting base 1 through screw connection, clasp fastening or plug-in connection. By forming a square frame 451 on the inner wall of the mounting part 45, a frame-shaped slot is formed between the square frame 451 and the edges of the mounting part 45. A frame-shaped bar 461 is farmed on the object-holding part 46. After the frame-shaped bar 461 is positioned in the frame-shaped slot of the mounting part 45, and the mounting part 45 is fixedly mounted on the mounting base 1, the frame-shaped bar 461 is located and fixed in the mounting part 45 by the mounting part 45 and the mounting base 1, thereby realizing the directional orientation of the frame-shaped bar 461. The square frame 451 acts as a support to the frame-shaped bar 461. In order to increase the stability of the mounted frame-shaped bar 461, the mounting part 45 is connected to the mounting base 1 by the screw. The periphery of the object holder mounting hole 12 in the mounting base 1 is preferably provided with a projection 19 used for abutting against and clamping the frame-shaped bar 461, such that the frame-shaped bar 461 will not be loose easily after being mounted. As for the plug-in connection adopted to fix the mounting part 45 in the third combined-type suction cup base, a left and a right bumps 172 may be arranged on the concave platform 17 to abut against and clamp the square frame 451 so as to prevent the square frame 451 from being loose. The division of the object holder 4 into the mounting part 45 and the object-holding part 46 facilitates the molding of complex object holders such as the soap box and the like, thereby facilitating the mass production and improving the production efficiency.

The suction cup base has a plurality of different object holders mounted on one mounting base in a combined manner, abandoning the combined model of spanning a cross rail between two mounting bases and mounting multiple different object holders on the cross rail. Thus, the suction cup base is simple and reasonable in structure, occupies less space, and is simple and convenient in operation, thereby meeting the consumers' personalized requirements of resting or hanging different objects, greatly facilitating the hanging or resting of objects by the consumer in the washroom or kitchen and the like, and making the whole washroom or kitchen more tidy and clean. Moreover, the suction cup base may also be fixed to an unsmooth wall surface by the screw, enlarging the range of use of the suction cup base.

The embodiments described above are merely preferred embodiments of the present invention which are not intended to limit the present invention. Other embodiments should all belong to the protection scope of the present invention as long as they achieve the technical effects of the present invention in any similar way.

1. A combined-type suction cup base, characterized in that the suction cup base comprises a mounting base, wherein the mounting base is provided with a through hole and a screw hole for passing a screw which is used to fix the mounting base onto a wall surface, one side of the through hole is connected with a suction cup with a screw stem which absorbs the mounting base to the wall surface, and the screw stem on the suction cup is in screw connection with a cap after passing through the through hole, the screw hole being located in the region covered by the cap; and at least two different object holders are directly and fixedly mounted on the mounting base, an object holder mounting hole in which a first screw rests is arranged on the mounting base, and the first screw being connected with the object holder after passing through the object holder mounting hole.

2. The combined-type suction cup base according to claim 1, characterized in that the suction cup base further comprises a screw stem fitting, wherein the screw stem fitting is in screw connection with the cap, and the cap comprises a suction cup lid and a soft rubber ring sleeved on the suction cup lid for increasing the frictional force when screwing the cap.

3. The combined-type suction cup base according to claim 1, characterized in that one side of the mounting base adjacent to the wall surface is provided with a first annular rib and a second annular rib for compressing the suction cup.

4. The combined-type suction cup base according to claim 1, characterized in that the object holder is a towel ring, a soap box, a toothbrush holder, a seasoning box, a hair dryer holder, a showerhead base, a plastic hook or a tissue box.

5. A combined-type suction cup base, characterized in that the suction cup base comprises a mounting base, wherein the mounting base is provided with a through hole and a screw hole for passing a screw which is used to fix the mounting base onto a wall surface, one side of the through hole is connected with a suction cup with a screw stem which absorbs the mounting base to the wall surface, and the screw stem on the suction cup is in screw connection with a cap after passing through the through hole, the screw hole is located in the region covered by the cap; and at least two different object holders are directly and fixedly mounted on the mounting base, a square hole is arranged on the mounting base, a clasp corresponding to the square hole is arranged on the object holder, and the object holder is fastened to the square hole in the mounting base by the clasp.

6. The combined-type suction cup base according to claim 5, characterized in that the suction cup base further comprises a screw stem fitting, wherein the screw stem fitting is in screw connection with the cap, and the cap comprises a suction cup lid and a soft rubber ring sleeved on the suction cup lid for increasing the frictional force when screwing the cap.

7. The combined-type suction cup base according to claim 5, characterized in that one side of the mounting base adjacent to the wall surface is provided with a first annular rib and a second annular rib for compressing the suction cup.

8. A combined-type suction cup base, characterized in that the suction cup base comprises a mounting base, wherein the mounting base is provided with a through hole and a screw hole for passing a screw which is used to fix the mounting base to a wall surface, one side of the through hole is connected with a suction cup with a screw stem which absorbs the mounting base to the wall surface, the screw stem on the suction cup is in screw connection with a cap after passing through the through hole, and the screw hole is located in the region covered by the cap; at least two different object holders are directly and fixedly mounted on the mounting base, a concave platform is arranged at the front part of the mounting base, on both sides of the concave platform are grooves recessed along the left and right sides, and one edge of the groove forms a boss; and the bottom of the concave platform is of a hollow structure, slots corresponding to the bosses are arranged on the left and right sides of the object holder, a notch is arranged at the bottom end of the slot, a trapezoidal projection is arranged on one side, facing away from the center of the object holder along the left and right direction, of the edge of the slot adjacent to the mounting base, corresponding to an extension part of the notch, a bottom slot is arranged at the bottom end of the object holder the object holder is in plug-in connection with the boss on the mounting base through the slot, the trapezoidal projection on the slot abuts against the bottom edge of the concave platform, an upper top edge of the object holder is fastened to the top edge of the mounting base, and two slot edges of the bottom slot of the object holder are located at two sides of the hollow structure of the concave platform.

9. The combined-type suction cup base according to claim 8, characterized in that the suction cup base further comprises a screw stem fitting, wherein the screw stem fitting is in screw connection with the cap, and the cap comprises a suction cup lid and a soft rubber ring sleeved on the suction cup lid for increasing the frictional force when screwing the cap.

10. The combined-type suction cup base according to claim 8, characterized in that one side of the mounting base adjacent to the wall surface is provided with a first annular rib and a second annular rib for compressing the suction cup.
